(19) United States
(12) Patent Application Publication
(10) Pub. No.: US 2026/0104135 A1
(43) Pub. Date: Apr. 16, 2026

(54) SELF-CORRECTING PLATFORM

(71) Applicant: ARTI SINHA, Bangalore (IN)

(72) Inventor: ARTI SINHA, Bangalore (IN)

(21) Appl. No.: 19/114,541

(22) PCT Filed: Sep. 24, 2023
(86) PCT No.: PCT/IB2023/059425

§ 371 Date: Mar. 24, 2025

(30) Foreign Application Priority Data
Sep. 24, 2022 (IN) 202241054831

(51) Int. Cl. F16M 11/42

(52) U.S. Cl. CPC F16M 11/42

(57) ABSTRACT

A self-correcting platform (100) includes at least one adjustable load bearing frame assembly (101) mounted on at least two-wheel assemblies (102). The adjustable load bearing frame assembly (101) includes a set of longitudinal beams (101a) spaced apart from each other and a set of lateral beams (101b) spaced apart from each other. The lateral beams (101b) are positioned in an orthogonal orientation relative to the set of longitudinal beams (101a) such that the set of longitudinal beams (101a) and the set of lateral beams (101b) are operably engaged with each other. The wheel assemblies (102) configured to support the at least one adjustable load bearing frame assembly (101) such that the wheel assemblies (102) are configured to restrict movement of the adjustable load bearing frame assembly (101) in a locked state and facilitate movement of the adjustable load bearing frame assembly (101) in an unlocked state.

### TECHNICAL FIELD

The present disclosure generally relates to building and building systems and related methods. More particularly, the present disclosure relates to self-correcting platforms along with its relocatable ground base.

### BACKGROUND

There is an Increasing demand for ready to use relocatable structures for temporary or transient occupancy; Project sites, Disaster relief sites and Sites for temporary use like vacant plots in Urban areas etc. There are many available solutions like container houses, PEBs, Expandable light weight houses etc. but they have limitations in size or in cost or in being 100% relocatable. For example, PEBs require traditional foundation which are not relocatable. Similarly, container houses have limitation of width (Standard width of container being ft) and Light weight expandable houses tend to be very costly and less sturdy. A foundation (or, more commonly, foundations form the lowest part of an architectural structure and are generally either shallow or deep. They and their construction are also sometimes called supporting structures, especially in the context of larger structures.

Shallow foundations, often called footings, are usually embedded about a meter or so into soil. A shallow foundation is a type of foundation which transfers building loads to the earth very near the surface, rather than to a subsurface layer or a range of depths as does a deep foundation. Shallow foundations include spread footing foundations, mat-slab foundations, slab-on-grade foundations, pad foundations, rubble trench foundations and earthbag foundations. Contemporarily, shallow foundations have been replaced by level platform structures that are portable or moveable. However, existing platforms, although moveable or portable, do not include self-correcting height mechanisms which enable the platform to be located at places having uneven height relative to the ground surface level. A platform, which is capable of adjusting height or based on detected abnormalities in the ground level height of a particular region, is therefore required.

Most of the existing products are lightweight and costly to make the shell as well as the interiors. Interiors of these products are mostly dry wall or ply or PVC material and as such interiors is neither sturdy nor have long life requiring high maintenance. Furthermore, existing platforms are incapable of actively sensing ambient conditions to either notify or actively alter parameters of the foundation or platform, for example, height, area, etc., based on the detected parameters. An improved platform, which actively engages with the environment using a combination of sensors to selectively alter dimensions or orientation of the platform without being prohibitively expensive to manufacture or use, is therefore desired.

Accordingly, there is a long felt but unresolved need for a self-correcting relocatable platform, which is capable of adjusting height or based on detected abnormalities in the ground level height of a particular region. Moreover, there is a need for an improved platform, which actively engages with the environment using a combination of sensors to selectively alter dimensions or orientation of the platform without being prohibitively expensive to manufacture or use.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The present disclosure addresses the above-mentioned need for a self-correcting platform, which is capable of adjusting height or based on detected abnormalities in the ground level height of a particular region. Moreover, the present disclosure addresses the need for an improved platform, which actively engages with the environment using a combination of sensors to selectively alter dimensions or orientation of the platform without being prohibitively expensive to manufacture or use.

The self-correcting platform, disclosed herein, includes at least one adjustable load bearing frame assembly mounted on a wheel assembly. The adjustable load bearing frame assembly includes a set of longitudinal beams spaced apart from each other and a set of lateral beams spaced apart from each other. The lateral beams are positioned in an orthogonal orientation relative to the set of longitudinal beams such that the set of longitudinal beams and the set of lateral beams are operably engaged with each other. The wheel assembly configured to support the at least one adjustable load bearing frame assembly such that the wheel assembly is configured to restrict movement of the adjustable load bearing frame assembly in a locked state and facilitate movement of the adjustable load bearing frame assembly in an unlocked state. The solution according to the disclosure is a modular prefinished structure mounted on self-correcting relocatable platforms. One advantage of such solution is the portability or improved ease of relocating the habitable unit due to the ease of relocating the foundation or platform on which the modular housing unit is mounted.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates a perspective view of a modular building mounted on a self-movable platform;

FIG. 2A exemplarily illustrates a top perspective view of the self-movable platform;

FIG. 2B exemplarily illustrates a top plan view of the self-movable platform;

FIG. 3A exemplarily illustrates a front elevation view of the self-movable platform;

FIG. 3B exemplarily illustrates an enlarged view of a wheel assembly of the self-movable platform shown in FIG. 3A;

FIG. 4A exemplarily illustrates a side view of the self-movable platform;

FIG. 4B exemplarily illustrates an enlarged side view of the wheel assembly of the self-movable platform shown in FIG. 4A;

FIG. 5A exemplarily illustrates a top perspective view of a locking mechanism of the wheel assembly of the self-movable platform;

FIG. 5B exemplarily illustrates a front elevation view of a locking mechanism of the wheel assembly of the self-movable platform; and

FIG. 5C exemplarily illustrates a side view of a locking mechanism of the wheel assembly of the self-movable platform.

### DETAILED DESCRIPTION OF THE EMBODIMENTS OF THE INVENTION

The following reference numbers are used throughout the description to refer to elements in the figures:
100—Self-correcting platform
101—Adjustable load bearing frame assembly
101a—Longitudinal beams
101b—Lateral beams
102—Wheel Assembly

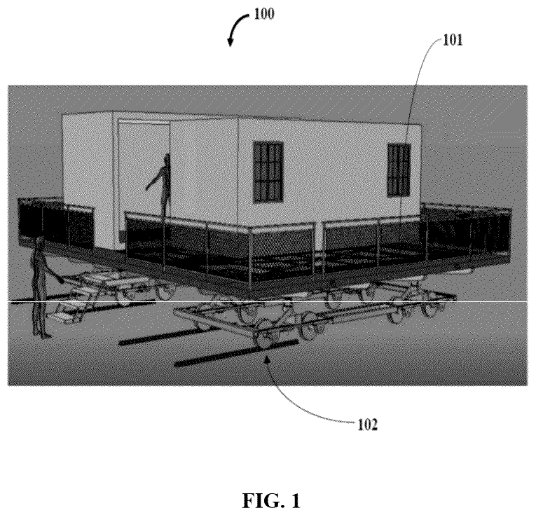

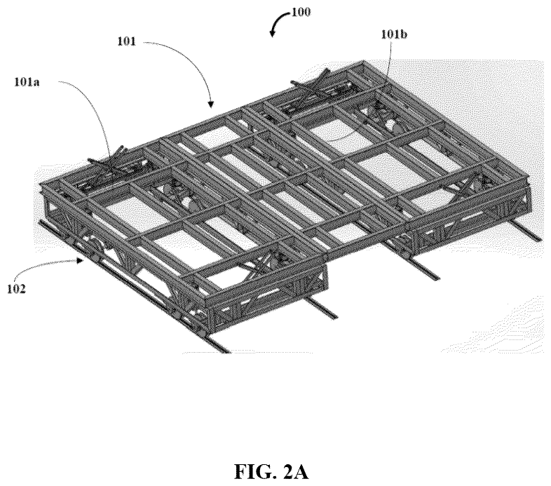

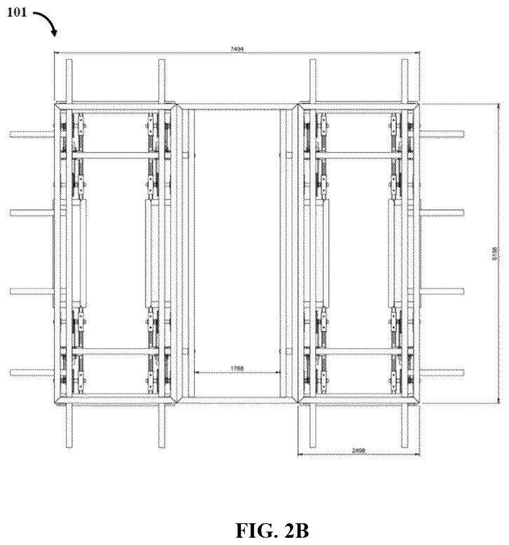

FIG. 1 exemplarily illustrates a perspective view of a modular building mounted on a self-correcting platform 100. FIG. 2A exemplarily illustrates a top perspective view of the self-movable platform 100. FIG. 2B exemplarily illustrates a top plan view of the self-movable platform. The self-movable platform 100 includes at least one adjustable load bearing frame assembly 101 mounted on at least two-wheel assemblies 102. The self-correcting platform 100 includes the at least one adjustable load bearing frame assembly 101 comprising a set of longitudinal beams 101a spaced apart from each other and a set of lateral beams 101b spaced apart from each other. The set of lateral beams 101b are positioned in an orthogonal orientation relative to the set of longitudinal beams 101a. In an embodiment, the set of longitudinal beams 101a and the set of lateral beams 101b are fabricated from steel. Mostly mild steel is used. In many cases cast iron or stainless steel or aluminum can also be used. Moreover, the set of longitudinal beams 101a and the set of lateral beams 101b are operably engaged with each other. For example, the longitudinal beams 101a may be fastened to the lateral beams 101b using screw thread fasteners, nut and bolt fasteners, etc. Alternatively, the longitudinal beams 101a may be welded to the lateral beams 101b.

In an embodiment, the set of longitudinal beams 101a and the set of lateral beams 102 are height adjustable. For example, the longitudinal beams 101a or lateral beams 101b may be actuated using hydraulic actuators to raise or lower the longitudinal beams 101a. The set of longitudinal beams 101a are expandable and retractable. This means the longitudinal beams 101a may be configured to have linkages or telescopic arrangements to facilitate expansion or retraction of the longitudinal beams 101a. In other exemplary embodiments according to the present disclosure, the set of longitudinal beams 101a are actuated to expand or retract using a mechanical drive mechanism or an electric drive mechanism.

The at least two-wheel assemblies 102 configured to support the at least one adjustable load bearing frame assembly 101. The attachment between the wheel assembly 102 and the adjustable load bearing frame assembly 101 is through a lead screw and cross bar arrangement. In an embodiment, a lead screw and cross bar arrangement are used to move the wheel assembly 102 in the height adjusting phase, which is powered by hydraulic cylinders at the corners of the self-correcting platform 100. While in normal/other times the wheels movements are locked and weight of upper structure is transferred directly to the wheel assembly 102. In an embodiment, the total weight of the self-correcting platform 100 is at least 25 tons. As such, to prevent excessive load transfer to the base ground causing the base ground to sink, rails, sleepers and ballast are used to transfer upper structure load to the ground effectively like a railway bogie. Moreover, the rails facilitate the movement of the wheel assembly 102 (to adjust height. This is a distinct feature of this design. The at least two-wheel assemblies 102 is configured to restrict movement of the at least one adjustable load bearing frame assembly 101 in a locked state and facilitate movement of the at least one adjustable load bearing frame assembly 101 in an unlocked state. The self-correcting platform 100 further comprises a controller and a set of sensors positioned along the longitudinal beams 101a and lateral beams 101b. The sensors may include, but are not limited to, proximity sensors, image processing sensors, motion sensors, accelerometers, gyroscopes, and magnetic sensors. These sensors may detect the profile of the terrain and notify users via an electronic device in communication with the controller of the self-correcting platform 100. Based on the detected parameters, the controller may control the actuating mechanisms of the adjustable load bearing frame assembly 101 to accordingly raise or lower the height of the self-correcting platform 100. Alternatively, the controller controls the longitudinal beams 101a to expand or retract using linkages or telescopic arrangements.

Other types of sensory arrangements may be envisioned, for example, to monitor numerous environmental conditions to ensure certain ambient conditions such as temperature, relative humidity, air velocity, differential pressure, airborne particle counts. etc., fall within a specified range. The data acquired by the sensors may be used to create a recorded database of the preferred range of ambient conditions and to sound an alarm should any environmental parameter fall outside a specified range, and to provide feedback for the systems of the self-correcting platform 100. Typically, a large number of such sensors are used in any environment, especially if a dozen or more sensors are used to monitor mini-environments at various locations outside the self-correcting platform 100. Each such sensor may require its own power source, user interface, and separately configured control device that determines and allows the user to adjust the sensor's operating parameters (e.g., output range scale, set points, calibration, sampling interval, high/low alarm limits, etc.

Some of the sensors contemplated for use with the present invention include solid state air velocity sensors, capacitive sensing differential pressure sensor, thin film capacitor relative humidity sensors, and platinum RTD temperature sensors. Because all the sensors plugged into a central control unit are automatically identified, the central control unit can also detect the absence of a particular sensor or sensor type. The present invention may include a single central monitoring unit that automatically supplies all the power needed to operate the sensor devices, identifies sensors that are connected to the system, configures appropriate operating parameters without operator intervention, and provides centralized simultaneous control, monitoring and recording for the plurality of sensors and the data provided thereby. The monitoring unit may also generate an appropriate display of the data from the sensors on a visual display or on an audio device as an audio notification to a user.

The self-correcting platform 100 is innovative mechanical design and systems enabled by remote sensing and programming concepts to make a product that is automated, highly dependable and efficient to serve a use case that provides alternate habitable space in a very unique way. Computer implemented software is used to automate platform levelling. The intelligent self-correcting platform 100 automatically adjusts to give a large floor space, for example, greater than 380 sq. ft. The self-correcting platform 100 automatically adjusts the height of the platform irrespective of the natural terrain up to a height of 8 inches.

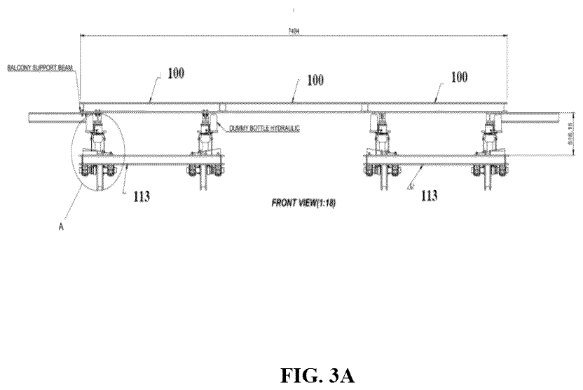

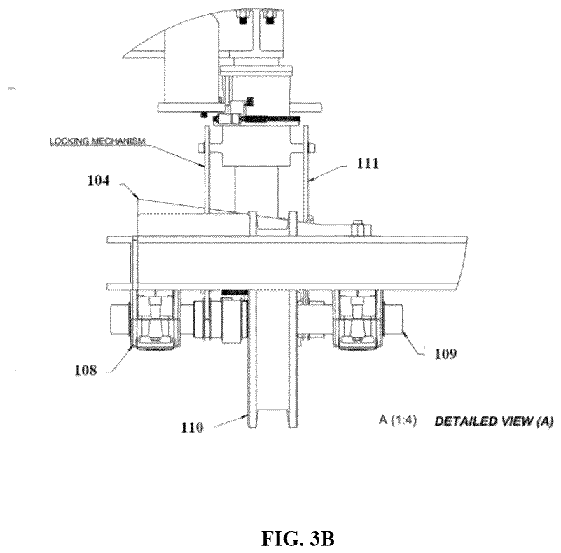

FIG. 3A exemplarily illustrates a front elevation view of multiple self-correcting platforms 100 arranged side by side. FIG. 3B exemplarily illustrates an enlarged view of a wheel assembly 102 of the self-correcting platform shown in FIG. 3A, Further, the self-correcting platform 100 includes a lower platform 113 detachably mounted across the at least two-wheel assemblies 102. The enlarged view of the wheel assembly 102 exemplarily illustrates the bracket 104 and the pivoting links 111 connected to the wheels 110. Two axle bearing seats 108 extend downward from the sliders for receiving wheel mounting axles 109. Each “modular self-correcting platform 100” is roughly 8 ft wide in size. In an embodiment, the length of the self-correcting platform 100 may vary between 20 ft and 40 ft depending on the upper structure design. For example, the critical dimension is 8 ft width which allows for ease of transportation (as per the allowable width as per Indian road transport guidelines, In an embodiment, a large platform can be assembled by positioning several similar sized self-correcting platforms 100 side by side. Underlying concept is that multiple self-correcting platforms 100 positioned side by side when “perfectly levelled” will act like a large platform with surface area equal to sum of constituent self-correcting platforms 100.

In an embodiment, the load exerted by the upper structure is transferred to the base ground by a pair of wheels 110 connected to the self-correcting platform 100. Levelling may be achieved in two iterations. For example, in the first iteration, the individual self-correcting platform 100 is corrected for any tilt using gyroscope-based sensors. As a result of this iteration, each self-correcting platform 100 is made parallel to the ground. For the next iteration, height difference between adjacent or all self-correcting platforms 100 are achieved. This is done using proximity and laser sensors. As a result of this iteration, all the constituent self-correcting platforms 100 of the system are levelled. In an embodiment, the levelling points are the corners of each self-correcting platform 100. One or multiple levelling points are adjusted in height to bring the combination of platforms at one level. A leveling point is moved up or down using external jacks (Hydraulic, Pneumatic or Electric. The jack is either manually operated (In low-cost products or are automated using actuators.

In an exemplary embodiment, the self-correcting platform 100 also includes the at least one controller configured to receive information associated with one or more parameters of at least one subcomponent of the self-correcting platform 100. In an embodiment, the at least one subcomponent includes the at least one adjustable load bearing frame assembly 101, the set of longitudinal beams 101a, the set of lateral beams 101b, and the at least one wheel assembly 102. In an embodiment, the at least one controller is configured to receive the information associated with the one or more parameters from the sensors. The sensors used may include a combination of angular velocity sensors, motion sensors, accelerometers, gyrometers, etc. The sensors detect the one or more parameters including, for example, a height of the set of longitudinal beams 101a and the set of lateral beams 101b, an inclination of the set of longitudinal beams 101a and the set of lateral beams 101b, and a position of the set of longitudinal beams 101a and the set of lateral beams 101b. Alternatively, the one or more parameters may also include, for example, motion, an angular velocity, a speed, and an acceleration of the at least one wheel assembly 102.

As used herein, the at least one controller refers to any one or more microprocessors, central processor (CPU) devices, finite state machines, computers, microcontrollers, digital signal processors, logic, a logic device, a user circuit, an application specific integrated circuit (ASIC), a field-programmable gate array (FPGA), a chip, etc., or any combination thereof, capable of executing computer programs or a series of commands, instructions, or state transitions. In an embodiment, the processor 104 is implemented as a processor set comprising, for example, a programmed microprocessor and a math or graphies co-processor, The processor 104 is selected, for example, from the Intel® processors such as the Itanium®microprocessor or the Pentium® processors, Advanced Micro Devices (AMD®) processors such as the Athlon® processor, UltraSPARC® processors, microSPARC® processors, hp® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, Qualcomm& processors, etc. The at least one controller may be communicatively coupled to a memory unit and configured to execute a set of computer program instructions defined by modules of the self-correcting platform 100.

In an embodiment, the memory unit stores a predefined threshold associated with the received information. The memory unit may be embedded within the self-correcting platform 100 or may be provided in a remote server or an electronic device, such as a mobile device, a laptop, a personal computer, a tablet, etc. The at least one controller determines if the received information equals or exceeds a predefined threshold. In an embodiment, the predefined threshold may be user defined. As used herein, “the predefined threshold” refers to predefined limits of sensor values that are set in the firmware to be within acceptable levels. Finally, the at least one controller controls the at least one subcomponent of the self-correcting platform 100 to maintain the information associated with the one or more parameters below the predefined threshold.

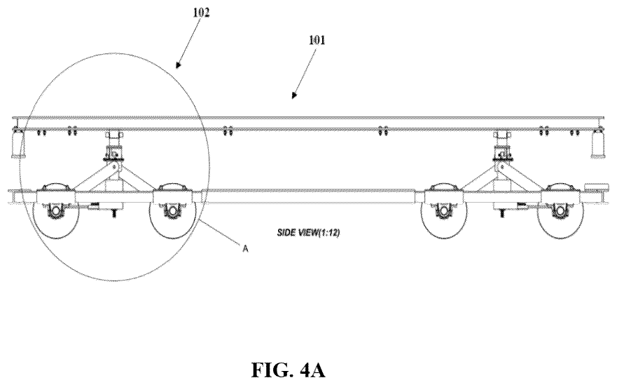

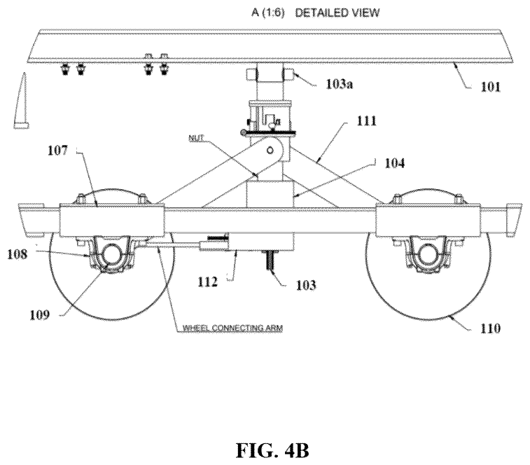

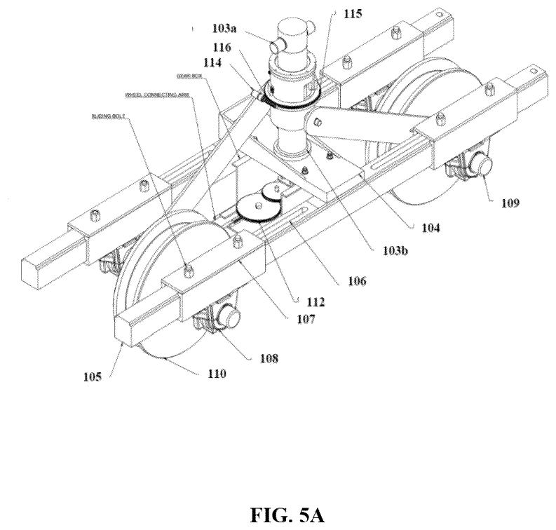

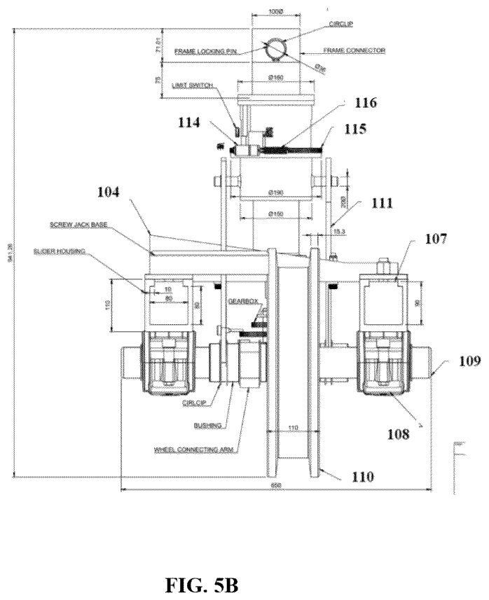

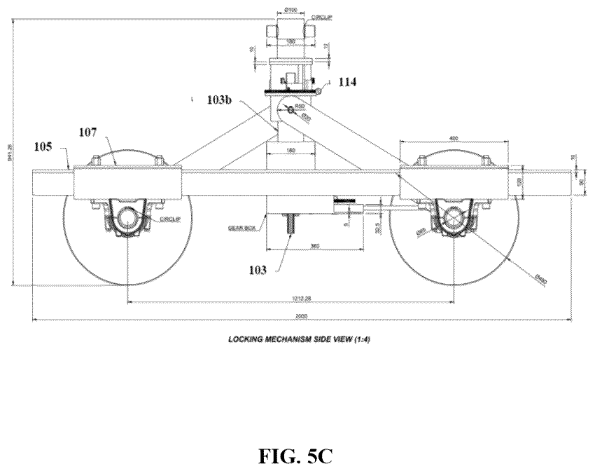

FIG. 4A exemplarily illustrates a side view of the self-correcting platform 101. FIG. 4B exemplarily illustrates an enlarged side view of the wheel assembly 102 of the self-correcting platform 101 shown in FIG. 4A. Each of the at least two-wheel assemblies 102 includes a lead screw 103, at least two wheels 110, pivoting links 111, and a compound gear system 112. In an embodiment, the lead screw 103 is configured to detachably mount the at least one adjustable load bearing frame assembly 101 at a first end using a frame locking pin 103a. Moreover, the lead screw 103 is detachably mounted on a central portion of a bracket 104 at a second end of the lead screw 103, At least two sliding guides 105 that are spaced apart as exemplarily illustrated in FIG. 5A includes sliders 107 positioned within sliding slots. The wheel assemblies 102 further include axle bearing seats 108 extending downward from the sliders 107 for receiving wheel mounting axles 109. The two wheels 110 are mounted on the wheel mounting axles 109 such that the wheels 110 are pivotably attached to the lead screw 103 via pivoting links 111. The at least two wheels 110 are coupled to the lead screw 103 via a compound gear system 112.

FIG. 5A exemplarily illustrates a top perspective view of a locking mechanism of the wheel assembly 102 of the self-correcting platform 100. FIG. 5B exemplarily illustrates a front elevation view of a locking mechanism of the wheel assembly 102 of the self-correcting platform 100. FIG. 5C exemplarily illustrates a side view of a locking mechanism of the wheel assembly 102 of the self-correcting platform 100. As disclosed in the detailed description of FIGS. 4A-4B, the self-correcting platform 100 includes at least two-wheel assemblies 102 such that each of the wheel assemblies 102 includes a lead screw 103 configured to detachably mount the at least one adjustable load bearing frame assembly 101 at a first end using a frame locking pin 103a. The lead screw 103 is detachably mounted on a central portion of a bracket 104 at a second end of the lead screw 103 using a lead screw nut 103b. At least two sliding guides 105 are configured to support opposing edges of the bracket 104. Further, the bracket 104 is oriented perpendicular to the at least two sliding guides 105. Each of the at least two sliding guides 105 are spaced apart and include sliding slots 106. In an embodiment, the sliding slots are configured along portions of the sliding guides 105 proximal to opposing sides of the bracket 104.

In an exemplary embodiment according to the present disclosure, the sliders 107 are positioned within the sliding slots 106. In an unlocked state, the sliders 107 are configured to move within the sliding slots 106. Further, the axle bearing seats 108 extend downward from the sliders 107 for receiving wheel mounting axles 109. At least two wheels 110 positioned in a space between the two sliding guides 105, the at least two wheels 110 mounted on the wheel mounting axles 109, wherein the at least two wheels 110 are pivotably attached to the lead screw 103 via pivoting links 111, and wherein the at least two wheels 110 are coupled to the lead screw 103 via a compound gear system 112. A rotation of the lead screw 103 adjusts a height of the set of longitudinal beams 101a and the set of lateral beams 102 of the adjustable load bearing frame assembly 101. A rotation of the lead screw 103 causes either an extension or a retraction of the at least two wheels 110.

The self-correcting platform 100 also includes a locking mechanism to restrict movement of the adjustable load bearing frame assembly 101. The locking mechanism includes a locking motor 114 and a locking gear 115 coupled to the lead screw 103. In an embodiment, the locking gear 115 is configured to be driven by the locking motor 114 via a worm gear 116. The lead screws 103 function as the main load bearing members of the system. They transfer load from the upper structure to the wheels 110 below. Though they take loads for most of the time, things are different in the level adjustment phase. During the level adjustment phase, the level adjustment is primarily triggered by the jacks at the “leveling points”. During adjustment, the following sequence of events are implemented. First, the lead screw 103 is disengaged. The load of the upper structure is taken by a levelling jack. The load jack moves the leveling point on the upper frame by a small distance (30 mm. At this stage, the lead screw 103 of adjacent three point gets disengaged with the upper platform (and the load is taken by Jack head.

The system is locked in position so that the lead screw 103 continues to be disengaged throughout the levelling process. The 30 mm gap between the lead screw 103 and the adjustable load bearing frame assembly 101 is “locked in position” by a frame locking pin 103a. The level adjustment is also completed by treading the lead screw 103 upward or downward. The level adjustment is done by the jacks by moving the adjustable load bearing frame assembly 101 upwards or downwards as required. The movement of the adjustable load bearing frame assembly 101 has a parallel event sequence affecting the position of the lead screw 103. When the adjustable load bearing frame assembly 101 moves up or down, the wheels 110 move forward or backward since the wheels are connected to the lead screw 103 through pivoting links 111. The movement of wheels 110 is translated to “treading up” or “treading down” of lead screw 103 through a combination of tracks and the compound gear system 112. The gear ratio is adjusted so that the movement of the lead screw 103 is equal to the movement of the adjustable load bearing frame assembly 101. The adjustable load bearing frame assembly 101 is thus unlocked, and the lead screw 103 is re-engaged. After the desired height is achieved, the frame locking pin 103a is moved to unlock the system. This allows for the adjustable load bearing frame assembly 101 to move down and rest on the lead screw 103 (after covering and cover the 30 mm gap*.

The self-correcting platform 100 uses rails as the base structural member which effectively spreads the load above to the base earth. In an embodiment, the rails are held in position by a sequence of sleepers (similar as in a railway line. The rail also facilitates the movement of the wheels 110, which is an important trigger for “treading up” and “treading down” of the lead screw 103 (an important step in the levelling of floors. The rails perform dual functions of level adjustment and load transfer. The ballast functions as the base to allow for natural flow. The reuse or recycle of rails, sleepers and other scrapped railways components ensures a constructive step towards green initiatives of society.

Several types of upper structures can be envisioned to be used with the self-correcting platform 100. For example, a collapsible transportable Box structure having a dimension 8 ft wide and 20-40 ft long. The critical dimension of such a structure is 8 ft width and the length can vary from 20 ft to 40 ft, depending on the design feasibility. Width 8 ft is critical as the Road transport has this width limitation for anything moving on Indian roads. The design is such that a set of 2 Boxes are positioned one inside another. The 2nd Box extends from inside the 1st Box. The 2 Boxes form the 2 floor plates. The 3rd floor plate is the cover flap of the collapsed transportable box.

Another type of upper structure includes the extended structure. The basic unit is designed to be extruded to 3 times its width. The width in expanded form shall be 24 ft, while the length will be fixed (20 ft or 40 ft) as per point 2 above. This design includes a set of 2 Boxes one inside another such that the 2nd Box extends from inside the 1st Box. The 2 Boxes form the 2 floor plates. The 3rd floor plate is the cover flap of the collapsed transportable box. Extruding the 2nd Box and Lowering of 3rd Floor Plate is based system of hydraulics, casters, and hinges and pulley chains.

Yet another implementation includes the prefinished type upper structure. The basic and extended structures as defined above are supposed to be very sturdy in design and material. The Basic unit will be extended, collapsed, and transported many times during the life span on the product. Ideal suitable material is imagined to be having strength like concrete. The flat surfaces may receive finishes like tiling directly without any leveling members. For such systems, the services like water supply, wastewater, electricity, Gas, and IT are designed to be facilitated from below the floor. The system is designed to install, use, and maintain them (services from below the floor. Most features for use are plug and play type. Maintenance is designed to be with smart accesses thru floor trap and trays. The upper structure may be transported many times during its lifetime and all enables to be incorporated in design to facilitate.

The foregoing examples have been provided merely for the purpose of explanation and are in no way to be construed as limiting of the self-correcting platform 100, disclosed herein. While the self-correcting platform 100 has been described with reference to various embodiments, it is understood that the words, which have been used herein, are words of description and illustration, rather than words of limitation. Further, although the self-correcting platform 100 has been described herein with reference to particular means, materials, and embodiments, the self-correcting platform 100 is not intended to be limited to the particulars disclosed herein; rather, the self-correcting platform 100 extends to all functionally equivalent structures, methods and uses, such as are within the scope of the appended claims. Those skilled in the art, having the benefit of the teachings of this specification, may affect numerous modifications thereto and changes may be made without departing from the scope and spirit of the self-correcting platform 100 disclosed herein in their aspects.

I claim:

1. A self-correcting platform (100) comprising at least one adjustable load bearing frame assembly (101) mounted on at least one wheel assembly (102), the self-correcting platform (100) characterized by:
the at least one adjustable load bearing frame assembly (101) comprising:
a set of longitudinal beams (101a) spaced apart from each other;
a set of lateral beams (101b) spaced apart from each other and positioned in
an orthogonal orientation relative to the set of longitudinal beams (101a),
wherein the set of longitudinal beams (101a) and the set of lateral beams (101b) are affixed to each other to define a platform; and
the at least one wheel assembly (102) configured to support the at least one adjustable load bearing frame assembly (101), wherein the at least one wheel assembly (102) is configured to:
restrict movement of the at least one adjustable load bearing frame assembly (101) in a locked state; and
facilitate movement of the at least one adjustable load bearing frame assembly (101) in an unlocked state,

2. The self-correcting platform (100) as claimed in claim 1, wherein the set of longitudinal beams (101a) and the set of lateral beams (102) are height adjustable.

3. The self-correcting platform (100) as claimed in claim 1, wherein the set of longitudinal beams (101a) are expandable and retractable.

4. The self-correcting platform (100) as claimed in claim 3, wherein the set of longitudinal beams (101a) are actuated to expand or retract using a mechanical drive mechanism.

5. The self-correcting platform (100) as claimed in claim 3, wherein the set of longitudinal beams (101a) are actuated to expand or retract using an electric drive mechanism.

6. The self-correcting platform (100) as claimed in claim 1, further comprising at least one controller configured to:
receive information associated with one or more parameters of at least one subcomponent of the self-correcting platform (100);
determine if the received information equals or exceeds a predefined threshold;
control the at least one subcomponent of the self-correcting platform (100) to maintain the information associated with the one or more parameters below the predefined threshold.

7. The self-correcting platform (100) as claimed in claim 6, wherein the at least one subcomponent comprises the at least one adjustable load bearing frame assembly (101), the set of longitudinal beams (101a), the set of lateral beams (101b), and the at least one wheel assembly (102).

8. The self-correcting platform (100) as claimed in claim 6, wherein the one or more parameters comprise a height of the set of longitudinal beams (101a) and the set of lateral beams (101b), an inclination of the set of longitudinal beams (101a) and the set of lateral beams (101b), and a position of the set of longitudinal beams (101a) and the set of lateral beams (101b).

9. The self-correcting platform (100) as claimed in claim 6, wherein the predefined threshold is user defined.
